(19) United States
(12) Patent Application Publication
(10) Pub. No.: US 2016/0294229 A1
(43) Pub. Date: Oct. 6, 2016

(54) ELECTRIC ROTATING MACHINE WITH LATERALLY MAGNETIZED MAGNETS

(71) Applicant: Siemens Aktiengesellschaft, Munchen (DE)

(72) Inventors: BENJAMIN VOLKMUTH, Sulzthal (DE); ROLF VOLLMER, Gersfeld (DE)

(73) Assignee: Siemens Aktiengesellschaft, Munchen (DE)

(21) Appl. No.: 15/087,464

(22) Filed: Mar. 31, 2016

(30) Foreign Application Priority Data
Apr. 1, 2015 (EP) 15162240.4

(51) Int. Cl. H02K 1/17; H02K 1/20; H02K 1/22; B60K 1/00; H02K 5/20; H02K 9/19; H02K 16/04; F03D 9/00; H02K 1/02; H02K 3/28

(52) U.S. Cl. CPC H02K 1/17; H02K 1/02; H02K 1/20; H02K 1/22; H02K 3/28; H02K 5/20; H02K 9/19; H02K 16/04; F03D 9/002; B60K 1/00; B60K 2001/006

(57) ABSTRACT

An electric rotating machine includes an outer stator, and an inner stator arranged inside the outer stator in concentric relationship to the outer stator. The inner stator has a plurality of permanent magnets which contain iron-neodymium-boron. A rotor is arranged in concentric relationship to the outer stator and the inner stator between the outer stator and the inner stator. The rotor is configured for movement in relation to the outer stator and the inner stator and defines with the inner stator an internal air gap there between. Each permanent magnet of the inner stator has a north pole and a south pole on a side facing the internal air gap.

### CROSS-REFERENCES TO RELATED APPLICATIONS

This application claims the priority of European Patent Application, Serial No. 15162240.4, filed Apr. 1, 2015, pursuant to 35 U.S.C. 119(a)-(d), the disclosure of which is incorporated herein by reference in its entirety as if fully set forth herein.

### BACKGROUND OF THE INVENTION

The present invention relates to an electric rotating machine with laterally magnetized magnets. The present invention further relates to a wind turbine with a generator which includes such an electric rotating machine, and to a drive for an electrically driven aircraft or an electrically driven vehicle or an electric traction vehicle with such an electric rotating machine.

The following discussion of related art is provided to assist the reader in understanding the advantages of the invention, and is not to be construed as an admission that this related art is prior art to this invention.

Electric machines are, for example, designed as synchronous machines, in particular as three-phase synchronous machines. Such three-phase synchronous machines may be operated, for example, as a motor or also as a generator and are found, for example, in wind turbines and aircraft drive systems which, for example, are designed as permanently excited three-phase synchronous machines. Furthermore, electric machines are known which have an outer stator and an inner stator, between which a rotor is arranged. Such dual-stator machines require a magnetic yoke made of magnetically soft iron in the inner stator. As a result, the inner stator has a higher mass, also requires the material iron and thereby also has poorer thermal conductivity to the magnets compared with aluminum or copper.

It would therefore be desirable and advantageous to obviate other prior art shortcomings and to provide an improved electric machine which, compared with the prior art, has a higher degree of efficiency with a lower mass and is more cost-effective.

### SUMMARY OF THE INVENTION

According to one aspect of the present invention, an electric rotating machine includes an outer stator, an inner stator arranged inside the outer stator in concentric relationship to the outer stator, the inner stator having a plurality of permanent magnets which contain iron-neodymium-boron, and a rotor arranged in concentric relationship to the outer stator and the inner stator between the outer stator and the inner stator, the rotor being configured for movement in relation to the outer stator and the inner stator and defining with the inner stator an internal air gap there between, with each permanent magnet of the inner stator having a north pole and a south pole on a side facing the internal air gap.

According to another aspect of the present invention, a wind turbine includes a generator, with the generator having an electric rotating machine, as set forth above.

According to still another aspect of the present invention, a drive for an electrically driven aircraft or an electrically driven vehicle or an electric traction vehicle includes an electric rotating machine, as set forth above.

An electric rotating machine with an outer stator, an inner stator arranged concentrically to the outer stator and a rotor arranged concentrically to the outer stator and to the inner stator between the outer stator and the inner stator is also called a dual-rotor machine. The special permanent magnets which have a north pole and a south pole on the side facing the internal air gap have lateral magnetization. One side of the individual permanent magnets has both poles, that is to say a north and a south pole. Advantageously, the magnetic material is reduced to the materials of the permanent magnet penetrated by the field lines, and a magnetic yoke as in traditional permanent magnets via, for example, an iron core is unnecessary.

As a result of the provision of a permanently excited three-phase synchronous machine in which the permanent magnets are arranged on the inner stator, the permanent magnets of the electric rotating machine do not need to be moved. Thus, heat generated during operation of the electric machine can be dissipated from the permanent magnets with greater ease than in the case of electric rotating machines in which the permanent magnets are provided in the rotor.

The permanent magnets of the inner stator contain neodymium iron boron. Neodymium iron boron is an alloy of neodymium, iron and boron from which the currently strongest permanent magnets are made. Furthermore the material neodymium iron boron belongs to the rare earth magnets. Such permanent magnets of the inner stator, which have iron, neodymium and/or boron, are furthermore characterized by high temperature resistance.

According to another advantageous feature of the present invention, the outer stator can have a plurality of windings. For that purpose, the outer stator may have corresponding grooves in which the windings are arranged.

According to another advantageous feature of the present invention, the inner stator can have a laminated core made of a light metal. Advantageously, aluminum can be used as light metal. As a result of the light metal in the inner stator, the mass of the inner stator is reduced. The motor is thereby lighter overall and the torque to mass ratio increases.

According to another advantageous feature of the present invention, the permanent magnets can be directly connected to the laminated core of the inner stator. This is possible as the laterally magnetized permanent magnets do not require an iron yoke in the inner stator. The laminated core, advantageously made of aluminum, retains, fastens and thus positions the permanent magnets. As a result, cooling of the permanent magnets directly connected to the inner stator is particularly efficient as the non-magnetic aluminum has greater thermal conductivity than iron and the iron, with its poorer thermal conductivity, is no longer necessary.

According to another advantageous feature of the present invention, the permanent magnets of the inner stator can be arranged almost without a gap in a peripheral direction and cover a surface of the inner stator facing the internal air gap almost completely. This is particularly advantageous as owing to the almost complete pole coverage of the permanent magnets on the periphery, torque is boosted with simultaneous optimization of the magnet volume. This reduces production costs and enables the production of rotors designed with both a large diameter and low inertia.

According to another advantageous feature of the present invention, the permanent magnets can have lenticular, trapezoidal or shell-shaped configuration. This configuration enables an almost constant air gap between the inner stator and the rotor. The shape of the permanent magnets depends on the requisite torque formation, the geometric dimensions and the requisite or intended air-gap induction.

According to another advantageous feature of the present invention, the permanent magnets can have a section which faces away from the internal air gap and essentially follows a preferred magnetic direction. It is significant here that no additional reflux material needs to be provided inside the rotor as a result of the lateral magnetization of the permanent magnets shaped in this way as both magnetic pole formation and magnetic field guidance occur in the permanent magnet.

According to another advantageous feature of the present invention, the rotor can include a support element which is made of a non-magnetic material and has a plurality of recesses in each of which a magnetically soft segment can be arranged. A non-magnetic material cannot usually be influenced by a magnetic field. A plurality of magnetically soft segments is embedded in the support element. As the inner stator of the electric rotating machine also has a plurality of permanent magnets, a permanently excited three-phase synchronous machine can be provided in which the permanent magnets are not moved during the operation of the electric rotating machine. Thus, heat generated during operation of the electric rotating machine can be dissipated from the permanent magnets with greater ease than in the case of electric rotating machines in which the permanent magnets are arranged in the rotor.

According to another advantageous feature of the present invention, the permanent magnets of the inner stator can be made of a ferrite. Ferrites are ferrimagnetic ceramic materials which have poor electric conductivity or are non-conductive. Standard materials are, for example, strontium ferrites, barium ferrites and cobalt ferrites. Such permanent magnets are more cost-effective compared with rare earth magnets.

According to another advantageous feature of the present invention, the electric rotating machine can have a first cooling device for cooling the permanent magnets of the inner stator. Heat generated during the operation of the electric machine can thus be reliably dissipated from the permanent magnets of the inner stator as a coolant. In this way, it is possible to prevent the permanent magnets from being demagnetized. It is thus possible to use magnets with lower coercive field strength. This in turn means that permanent magnets with a lower proportion of rare earth elements can be used. In this way, the remanence can be increased and the costs reduced.

According to another advantageous feature of the present invention, the electric machine can have a second cooling device for cooling the outer stator. The second cooling device can prevent the windings of the outer stator from overheating and thus possibly being damaged during operation of the electric machine. In this way the reliable operation of the electric machine is made possible.

According to another advantageous feature of the present invention, the first cooling device and/or the second cooling device can have a plurality of cooling pipes, through which a coolant flows. Water or a water-glycol mixture, for example, can be used as a coolant. Corresponding cooling pipes can be produced easily and inexpensively. In one embodiment the cooling pipes are arranged in a laminated core of the inner stator and/or in an iron core of the outer stator. For example, the cooling pipes of the first cooling device and/or the second cooling device can be provided through corresponding holes which are inserted into the respective iron core. Such cooling pipes are easy and inexpensive to produce.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross-section of one embodiment of an electric rotating machine according to the present invention;

FIG. 2 is a longitudinal section of the electric rotating machine of FIG. 1;

FIG. 3 is a perspective view of a detail of the electric rotating machine, depicting an inner stator with lenticular, laterally magnetized permanent magnets;

FIG. 4 is a cross-section of a detail of a variation of the electric rotating machine, depicting part of an inner stator with trapezoidal, laterally magnetized permanent magnets,

FIG. 5 is a perspective view of a detail of still another variation of the electric rotating machine, depicting part of an inner stator with shell-shaped, laterally magnetized permanent magnets,

FIG. 6 is a longitudinal section of a nacelle of a wind turbine; and

FIG. 7 is a longitudinal section of an electrically driven vehicle.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

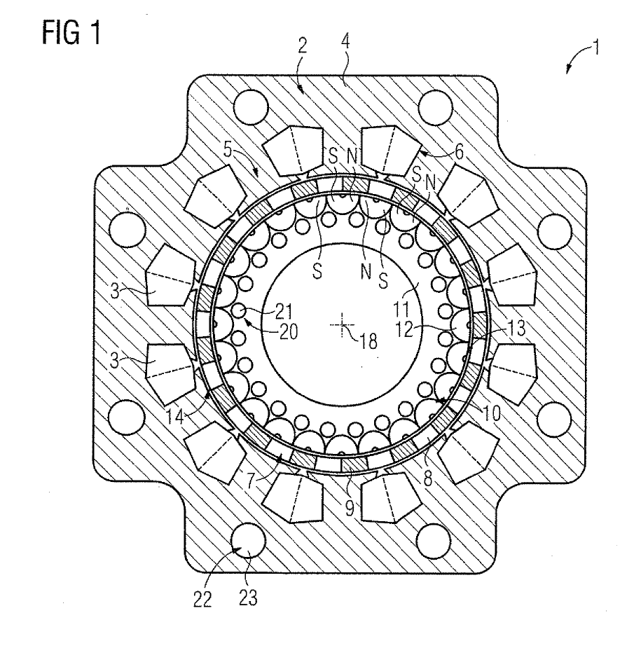

Turning now to the drawing, and in particular to FIG. 1, there is shown a cross-section of one embodiment of an electric rotating machine according to the present invention, generally designated by reference numeral 1. The electric rotating machine 1 has an outer stator 2, The outer stator 2 has an iron core 4 which has a plurality of teeth 5 with intermediate grooves 6. Corresponding windings 3 are introduced into the grooves 6. The windings 3 are usually connected electrically with a three-phase supply not shown here. A rotor 7 is arranged inside the outer stator 2. The rotor 7 is arranged concentrically to the outer stator 2 around its rotational axis 18. There is a second air gap 14 between the rotor 7 and the outer stator 2. The rotor 7 has a support element 8 which is composed of a non-magnetic material. The support element 8 has a number of recesses, in each of which magnetically soft segments 9 are embedded. In addition, the electric rotating machine 1 has an inner stator 10. The inner stator 10 is arranged concentrically around the rotational axis 18 of the rotor 7 inside the rotor 7. Between the rotor 7 and the inner stator 10 there is a first air gap 13. The inner stator 10 comprises a laminated core 11 which has a plurality of recesses, in each of which a permanent magnet 12 is arranged, wherein the permanent magnets 12 are directly connected to the laminated core 11 of the inner stator 10. Each individual permanent magnet 12 is laterally magnetized, in other words a rod magnet may be envisaged, the ends of which, or in other words the poles, are facing each other—in an extreme case are almost folded up, and has a north pole N and a south pole S on the side facing the internal air gap 13. This has the advantage of reducing the magnetic material on the materials of the permanent magnet penetrated by the field lines and obviating the need for a magnetic yoke as in traditional permanent magnets via, for example, an iron core. The laminated core 11 of the inner stator 10 can therefore be made of aluminum or another, also non-magnetic, light metal. Furthermore, the laterally magnetized permanent magnets 12 of the inner stator 10 are arranged in the peripheral direction of the inner stator 10 along the internal air gap 13 almost without a gap and cover the surface of the inner stator 10 facing the internal air gap 13 almost completely. An electric rotating machine 1 with an outer stator 2, an inner stator 10 arranged concentrically to the outer stator 2 and a rotor 7 arranged concentrically to the outer stator 2 and to the inner stator 10 between the outer stator 2 and the inner stator 10 is also called a dual-rotor machine.

The laterally magnetized permanent magnets 12 of the electric rotating machine 1 in FIG. 1 are shell-shaped but, for example, a lenticular or trapezoidal design is also possible.

A magnetic pole N or S of the inner stator 7 is composed of two contiguous like poles N, N or S, S of a permanent magnet 12. The permanent magnets 12 are furthermore designed such that the section of the permanent magnets 12 facing away from the internal air gap 13 essentially follows the preferred magnetic direction 26. The permanent magnets 12 can, for example, be made of a ferrite and/or, for example, contain neodymium-iron-boron.

In the present exemplary embodiment the outer stator 2 and/or its windings 3 have a number of pole pairs pw=5. The inner stator 10 and/or its permanent magnets 12 have a number of pole pairs pm=12. The rotor 7 in the present case has 17 magnetically soft segments 9. The number of pole pairs of the rotor is therefore pr=17. The outwardly effective number of pole pairs corresponds to the number of pole pairs of the rotor. In general, the number of pole pairs of the electric rotating machine 1 can be combined in accordance with the following formula:

pr=|pm+/−pw|.

The electric machine 1 in FIG. 1 has a first cooling device 20 for cooling the inner stator 10. The first cooling device 20 comprises a plurality of cooling pipes 21 which are arranged inside the laminated core 11 of the inner stator 12. As a result of the possibility of producing the laminated core 11 of the inner stator 12 from aluminum, for example, cooling of the permanent magnets 12 directly connected to the laminated core 11 of the inner stator 12 is particularly efficient, as aluminum has greater thermal conductivity than, for example, iron, from which the laminated core 11 is usually made.

The cooling pipes 21 are uniformly distributed in a peripheral direction of the inner stator 12 and extend along the axial direction of the electric rotating machine 1. The first cooling device 20 is intended to cool the permanent magnets 12.

In addition, the electric machine 1 comprises a second cooling device 22. The second cooling device 22 also comprises a plurality of cooling pipes 23 which extend along the axial direction of the electric machine. The cooling pipes 23 of the second cooling device 22 along the peripheral direction of the outer stator 2 are also uniformly distributed. A cooling medium, in particular, a coolant, can flow through the cooling pipes 21, 23. The windings 3 of the outer stator 2 can be cooled with the second cooling device. The heat which arises during the operation of the electric machine 1 can be dissipated from the inner stator 10 by means of the first cooling device 20. In this way, the permanent magnets 9 can be prevented from overheating and thus being demagnetized.

In addition, the electric rotating machine 1 has a second cooling device 22. The second cooling device 22 also has a plurality of cooling pipes 23 which extend along the axial direction of the electric machine. The cooling pipes 23 of the second cooling device 22 along the peripheral direction of the outer stator 2 are also uniformly distributed. A cooling medium, in particular, a coolant, can also flow through the cooling pipes 21, 23. The windings 3 of the outer stator 2 can be cooled with the second cooling device. The heat which arises during the operation of the electric machine 1 can be dissipated from the inner stator 10 by means of the first cooling device 20. In this way, the permanent magnets 9 can be prevented from overheating and thus being demagnetized.

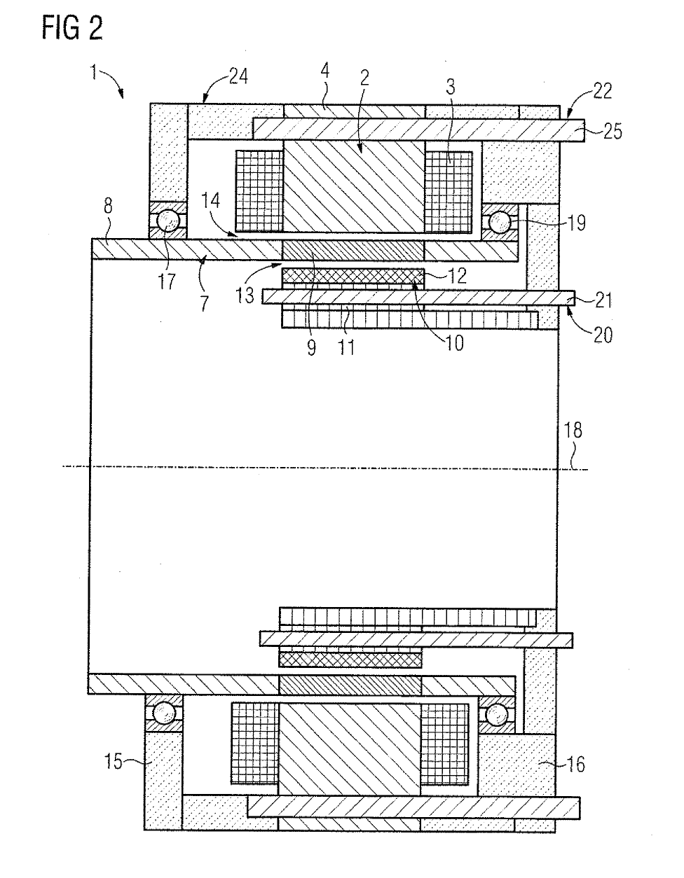

FIG. 2 shows a longitudinal section of the embodiment of the electric rotating machine 1 in accordance with FIG. 1. in addition to the aforementioned components, FIG. 2 shows a housing 24 of the electric rotating machine 1. The housing 24 has a first flange 15, which is also called an AS flange, and a second flange 16, which is also called a BS flange. A first bearing 17 is arranged between the first flange 15 and the rotor 7 and, for example, is designed as a ball bearing. A second bearing element 19 is arranged between the second flange 16 and the rotor 7, and may likewise be designed as a ball bearing. A shaft (not shown) is connected to the rotor 7.

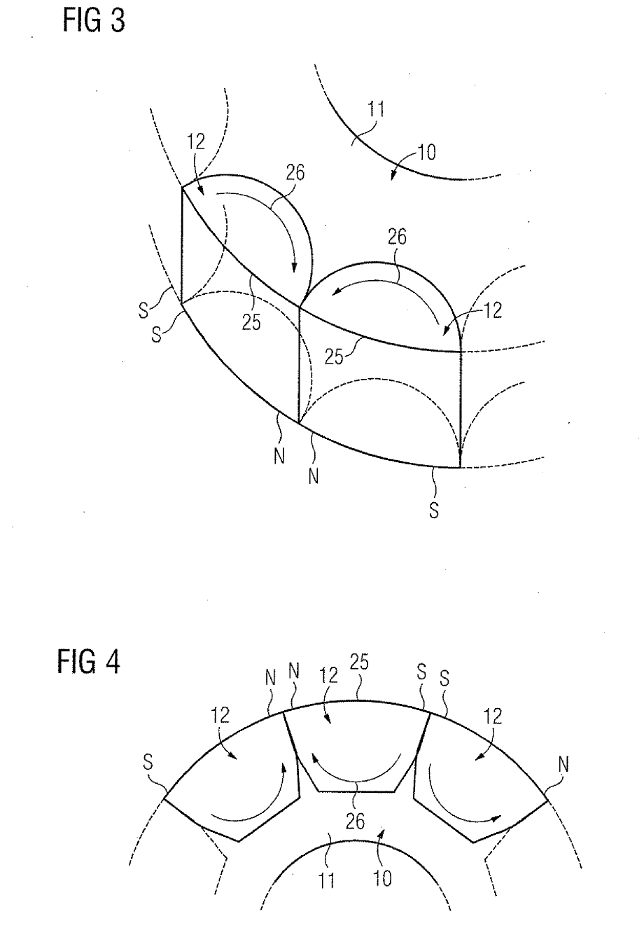

FIG. 3 shows a perspective view of part of an inner stator 12 with lenticular laterally magnetized permanent magnets 12. The lenticular shape, which corresponds to the shape of a biconvex lens, results from the fact that the design of the section 25 facing the internal air gap 13 and the design of the section facing the laminated core 11 are rounded, wherein the section 25 facing the laminated core 11 and facing away from the internal air gap 13 follows the preferred magnetic direction 26. The lenticular laterally magnetized permanent magnets 12 of the inner stator 10 are arranged almost without a gap in the peripheral direction and cover the external tangential surface of the inner stator 10 which corresponds to the external lateral surface of a hollow cylinder formed by the lenticular laterally magnetized permanent magnets 12 and the laminated core 11 almost completely. The respective north poles N and south poles S of the inner stator 10 are arranged on the joint areas of the lenticular laterally magnetized permanent magnets 12. A magnetic north pole N or south pole S of the inner stator 10 is formed by two contiguous like poles N, N or S, S of the permanent magnets 12. A bevel and/or graduation of the magnetic poles, viewed over the axial length of the rotor 7, is possible.

FIG. 4 shows a cross-section of part of an inner stator 10 with trapezoidal laterally magnetized permanent magnets 12. The trapezoidal shape results from the fact that the design of the section facing the laminated core 11 and facing away from the internal air gap 13 is trapezoidal, for example for reasons relating to the manufacturing process. It is also crucial here that as a result of the lateral magnetization of the trapezoidal permanent magnets 12, no additional reflux material is necessary inside the inner stator 10, as both magnetic pole formation and magnetic field guidance occur in the permanent magnet 12 itself. A magnetic north pole N or south pole S of the inner stator 10 is also formed here by two contiguous like poles N, N or S, S of the permanent magnets 12. A bevel and/or graduation of the magnetic poles, viewed over the axial length of the rotor 7, is also possible here.

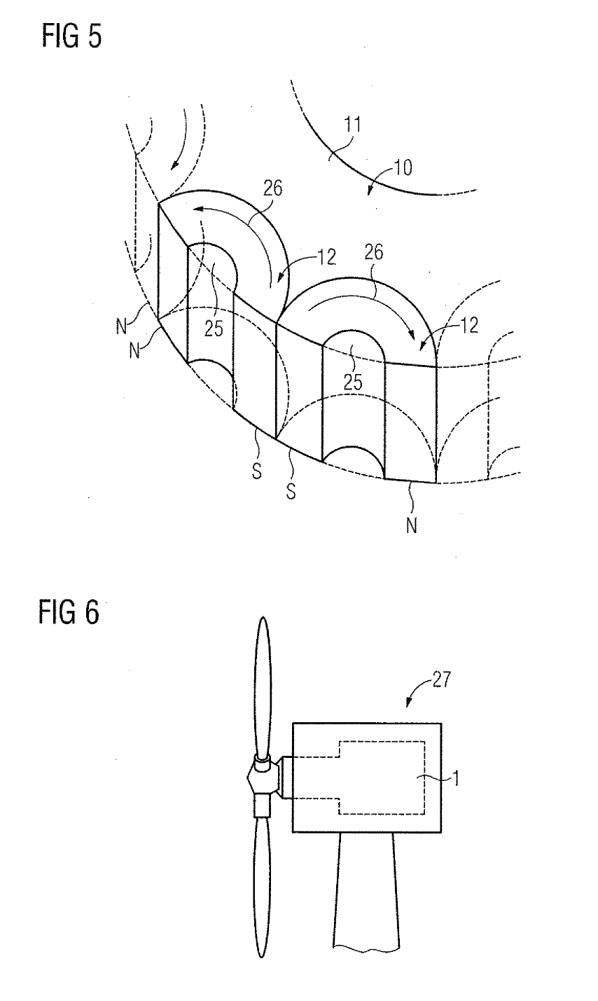

FIG. 5 shows a perspective view of part of an inner stator 10 with shell-shaped laterally magnetized permanent magnets 12. This additional embodiment of a laterally magnetized permanent magnet 12 differs from the lenticular shape shown in FIG. 3 in that, in addition, on the section 25 facing the internal air gap 13 there is a concave recess which produces the shell shape of the laterally magnetized permanent magnet 12. The sections on the left and right of the recess form the rounded shape of the inner stator 10. A magnetic north pole N or south pole S of the inner stator 10 is therefore also formed here by two contiguous like poles N, N or S, S of the permanent magnets 12. A bevel and/or graduation of the magnetic poles, viewed over the axial length of the rotor 7, is also possible here.

FIG. 6 shows a longitudinal section of a nacelle of a wind turbine 27, wherein an embodiment of an electric rotating machine 1 according to the invention is used in the wind turbine 27. The electric rotating machine 1 used as a generator can be driven directly (direct-drive) or via a gearbox. Such an electric rotating machine 1 preferably has multi-polarity, which is particularly important for direct-drive generators and preferably has comparatively high air-gap induction, which in turn increases the energy efficiency of the wind turbine 27.

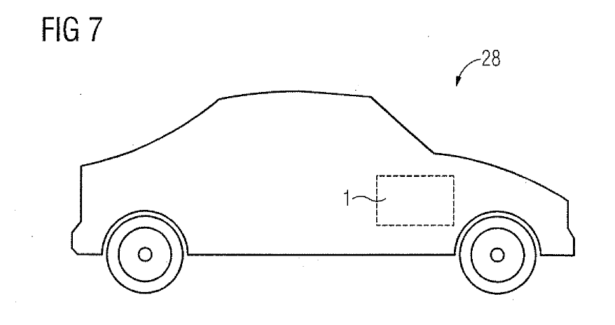

FIG. 7 shows a longitudinal section of an electrically driven vehicle 28, an embodiment of an electric rotating machine 1 according to the invention being used in the vehicle 28. The electric rotating machine 1 used as a motor can also be used together with a combustion engine, for example, in a hybrid vehicle.

In summary, the invention relates to an electric rotating machine 1 with an outer stator 2, an inner stator 10 which is arranged concentrically to the outer stator 2 inside the outer stator 2, a rotor 7 which is arranged concentrically to the outer stator 2 and the inner stator 10 between the outer stator 2 and the inner stator 10 and which can be moved relative to the outer stator 2 and the inner stator 10, and an internal air gap 13 which is arranged between the rotor 7 and the inner stator 10, wherein the inner stator 10 has a plurality of permanent magnets 12. In order to obtain a higher degree of efficiency with a lower mass and lower costs compared with the prior art, it is proposed that each individual permanent magnet 12 on the side facing the internal air gap 13 has a north pole N and a south pole S, wherein the permanent magnets (12) of the inner stator (10) contain iron-neodymium-boron.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. An electric rotating machine, comprising:
an outer stator;
an inner stator arranged inside the outer stator in concentric relationship to the outer stator, said inner stator having a plurality of permanent magnets which contain iron-neodymium-boron; and
a rotor arranged in concentric relationship to the outer stator and the inner stator between the outer stator and the inner stator, said rotor being configured for movement in relation to the outer stator and the inner stator and defining with the inner stator an internal air gap there between, with each permanent magnet of the inner stator having a north pole and a south pole on a side facing the internal air gap.

2. The electric rotating machine of claim 1, wherein the outer stator has a plurality of windings.

3. The electric rotating machine of claim 1, wherein the inner stator has a laminated core which is made from a light metal.

4. The electric rotating machine of claim 3, wherein the light metal is aluminum.

5. The electric rotating machine of claim 3, wherein the permanent magnets are directly connected to the laminated core of the inner stator.

6. The electric rotating machine of claim 1, wherein the permanent magnets of the inner stator are arranged substantially without a gap in a peripheral direction and substantially cover a surface of the inner stator facing the internal air gap.

7. The electric rotating machine of claim 1, wherein the permanent magnets have a lenticular, trapezoidal or shell-shaped configuration.

8. The electric rotating machine of claim 1, wherein the permanent magnets have a section which faces away from the internal air gap and essentially follows a preferred magnetic direction.

9. The electric rotating machine of claim 1, wherein the rotor comprises a support element which is made of a non-magnetic material and has a plurality of recesses, each said recess receiving a magnetically soft segment.

10. The electric rotating machine of claim 1, wherein the permanent magnets of the inner stator are made from a ferrite.

11. The electric rotating machine of claim 1, further comprising a cooling device configured to cool the permanent magnets of the inner stator.

12. The electric rotating machine of claim 1, further comprising a cooling device configured to cool the outer stator.

13. The electric rotating machine of claim 1, further comprising a first cooling device configured to cool the permanent magnets of the inner stator, and a second cooling device configured to cool the outer stator, at least one of the first and second cooling devices having a plurality of cooling pipes through which a coolant flows.

14. A wind turbine, comprising a generator, said generator including an electric rotating machine comprising an outer stator, an inner stator arranged inside the outer stator in concentric relationship to the outer stator, said inner stator having a plurality of permanent magnets which contain iron-neodymium-boron, and a rotor arranged in concentric relationship to the outer stator and the inner stator between the outer stator and the inner stator, said rotor being configured for movement in relation to the outer stator and the inner stator and defining with the inner stator an internal air gap there between, with each permanent magnet of the inner stator having a north pole and a south pole on a side facing the internal air gap.

15. A drive for an electrically driven aircraft or an electrically driven vehicle (28) or an electric traction vehicle, said drive comprising an electric rotating machine comprising an outer stator, an inner stator arranged inside the outer stator in concentric relationship to the outer stator, said inner stator having a plurality of permanent magnets which contain iron-neodymium-boron, and a rotor arranged in concentric relationship to the outer stator and the inner stator between the outer stator and the inner stator, said rotor being configured for movement in relation to the outer stator and the inner stator and defining with the inner stator an internal air gap there between, with each permanent magnet of the inner stator having a north pole and a south pole on a side facing the internal air gap.
